(19) United States
(12) Patent Application Publication
(10) Pub. No.: US 2026/0135628 A1
(43) Pub. Date: May 14, 2026

(54) MOST LIKELIHOOD SEQUENCE ESTIMATION ON REAL-TIME OSCILLOSCOPES

(71) Applicant: Tektronix, Inc., Beaverton, OR (US)

(72) Inventor: Kan Tan, Portland, OR (US)

(21) Appl. No.: 19/380,433

(22) Filed: Nov. 5, 2025

Related U.S. Application Data
(60) Provisional application No. 63/718,870, filed on Nov. 11, 2024.

(51) Int. Cl. H04B 17/309; H04B 17/391

(52) U.S. Cl. CPC H04B 17/309; H04B 17/3912

(57) ABSTRACT

A real-time oscilloscope includes one or more ports to connect to a device under test (DUT) to establish a communication channel between the oscilloscope and the DUT, one or more analog-to-digital converters (ADCs) to sample a signal received from the DUT to convert the signal to a waveform, one or more processors to receive and sample a run-time signal including actual symbols from the DUT to create a run-time waveform, resample the run-time waveform to locate samples at a center of each unit interval, use a communication channel characterization, the samples at the center of each unit interval, a symbol constellation for the run-time waveform, and a configuration of a traceback length as inputs to a Most Likely Sequence Estimation (MLSE) process to estimate symbols in the run-time waveform, and compare the estimated symbols to the actual symbols to obtain a symbol error ratio.

### CROSS-REFERENCE TO RELATED APPLICATIONS

This disclosure is a non-provisional of and claims benefit from U.S. Provisional Application No. 63/718,870, titled “MOST LIKELIHOOD SEQUENCE DETECTION ON REAL-TIME OSCILLOSCOPES,” filed on Nov. 11, 2024, the disclosure of which is incorporated herein by reference in its entirety.

### TECHNICAL FIELD

This disclosure relates to test and measurement instruments, and more particularly to symbol detection in transmitted symbols, more particularly in reducing errors in transmitted symbols.

### BACKGROUND

For high-speed serial data standards such as PCIE and IEEE 802.3 Ethernet, PAM4 signaling has been developed to replace NRZ signaling. The explicit solution is derived in U.S. Pat. No. 11,765,002 (the '002 patent), issued Sep. 19, 2023, for the decision feedback equalizer (DFE) taps based on the single extracted linear fit pulse response (LFPR). Tan et al., “Multiple Linear Fit Pulse Responses for PAM4 Measurements,” DesignCon 2024 Compiled Papers TR8-14, Feb. 22, 2024, pp 438-453, available at https://fliphtml5.com/mddwo/smbr/DesignCon_2024_Compiled_Papers_Tr_8-14/, hereinafter “Tan et al.,” the contents of which are hereby incorporated by reference into this disclosure, introduces a new method that can extract multiple LFPR from a pattern waveform.

Multiple LFPRs hold more information about the signal. The new DFE structure called multiple pulses based DFE (MPDFE) that uses the multiple LFPRs is introduced in U.S. patent application Ser. No. 18/754,871, filed Jun. 26, 2024, the contents of which are hereby incorporated by reference into this disclosure.

When the signal speed increases, the equalizers in transmitter and receiver are widely used to improve the system performance. The equalizers include continuous-time linear equalizer (CTLE), feedforward equalizer (FFE), decision feedback equalizer (DFE), and the new multiple-pulse DFE (MPDFE). Among the equalizers, the DFE and MPDFE detect the symbols and then use the detected symbols to improve the detection of the following symbols. If one symbol is detected incorrectly, as the wrong symbol is used in the feedback loop as shown in FIG. 1, the symbol error can cause a burst of multiple symbol errors, called error propagation.

### BRIEF DESCRIPTION OF THE DRAWINGS

FIG. 1 shows an embodiment of a decision feedback equalizer.

FIG. 2 shows an embodiment of a real-time oscilloscope.

FIG. 3 shows an embodiment of a trellis structure used in disclosed embodiments.

FIG. 4 shows an example of a 4-level pulse amplitude modulation (PAM4) waveform from a transmitted signal.

FIG. 5 shows a zoomed in view of the waveform of FIG. 4.

FIG. 6 shows a linear fit pulse response extracted from the waveform of FIG. 4, with samples at unit interval centers.

FIG. 7 shows the linear fit pulse response with samples at unit interval centers around the peak of the impulse.

FIG. 8 shows results from a most-likelihood sequence estimation (MLSE) for the PAM4 signal.

FIG. 9 shows a flowchart of an embodiment of a method of using MLSD to detect symbols in a waveform.

FIG. 10 shows an example of a PAM4 waveform after a channel that has higher loss.

FIG. 11 shows an impulse response for the channel of FIG. 10.

FIG. 12 shows the MLSE results for the PAM4 signal of FIG. 10.

### DETAILED DESCRIPTION

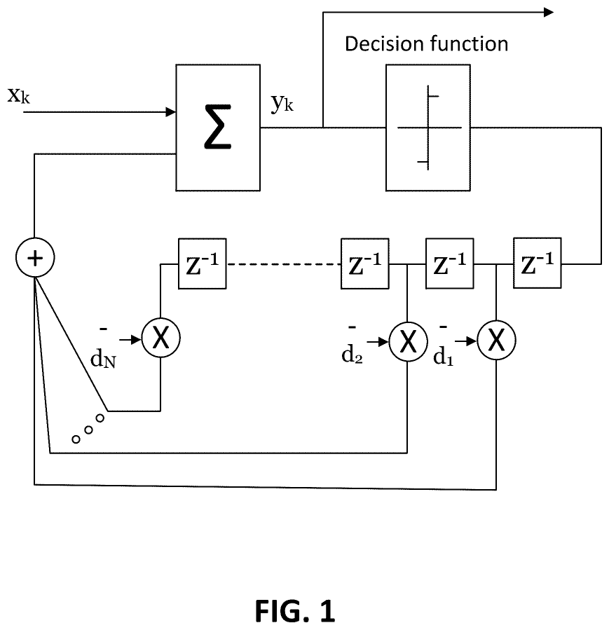

The embodiments here employ the Most Likelihood Sequence Estimation (MLSE) to estimate the symbols. MLSE is sometimes referred to as Most Likelihood Sequence Detection (MLSD). As discussed above, the equalizers DFE and MPDFE detect the symbols and then use the detected symbols to improve the detection of the following symbols. If one symbol is detected incorrectly, as the wrong symbol is used in the feedback loop as shown in FIG. 1, the symbol error can cause a burst of multiple symbol errors, called error propagation.

To achieve higher performance on symbol error rate, the embodiments disclosed herein employ Most Likelihood Sequence Estimation (MLSE. MLSE provides the optimal solution for symbol estimation on signals with noise and inter-symbol-interference (ISI). MLSE does not have error propagation issues as in the DFE. The embodiments herein involve a method that simulates MLSE on real-time oscilloscopes.

Real-time oscilloscopes generally digitize a signal in real-time, capturing and displaying a signal waveform in a single, continuous acquisition, typically using one or more high-speed analog-to-digital converters (ADCs) and an independent clock. They differ from the equivalent-time sampling oscilloscopes in that sampling oscilloscopes take multiple samples over several signal periods to “build” the complete waveform over time.

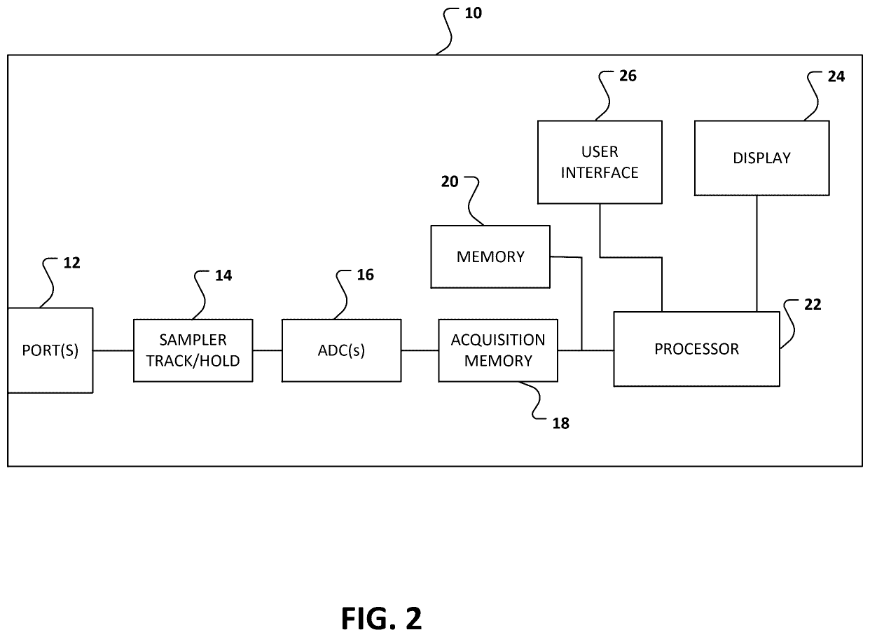

FIG. 2 shows an embodiment of a real-time oscilloscope 10. The real-time oscilloscope 10 includes one or more ports 12 which may be any electrical signaling medium. Ports 12 may include receivers, transmitters, and/or transceivers. Each port 12 is a channel of the test and measurement instrument 10.

The signal is sent to a sampler track and hold circuit 14. The track and hold circuit 14 holds each signal steady for a period of time sufficient to enable acquisition by one or more high-resolution analog-to-digital converter (ADC) 16. The analog-to-digital converter (ADC) 16 converts the analog signal from the track and hold circuit 14 to a digital signal. The one or more ADCs 16 will generally comprise high-speed ADCs. In some configurations, the one or more ADCs 16 can sample the analog signal at the sample rate between 1 GS/s to 100 GS/s. In other configuration, the analog-to-digital converters can sample the analog signal between 2 GS/s and 250 GS/s. The digitized signal from the ADCs 16 can then be stored in an acquisition memory 19. The analog-to-digital converter 108 could be a single high-resolution analog-to-digital converter, such as a 10-bit analog-to-digital converter. The oscilloscope may also have other memory 20 besides the acquisition memory 18. Memory 20 may store program instructions for the one or more processors 22, as well as other data as needed.

Memory 18 or any other memory 20 on the oscilloscope 10 may be implemented as processor cache, random access memory (RAM), read only memory (ROM), solid state memory, hard disk drive(s), or any other memory type. Memory acts as a medium for storing data, computer program products, and other instructions.

User inputs are received from the user interface 26 and coupled to the one or more processors 22. User interface 26 may include a keyboard, mouse, trackball, touchscreen, and/or any other controls employable by a user to interact with a GUI on display 24. The display 116 may be a digital screen, or any other monitor to display waveforms, measurements, and other data to a user. The display and the user interface may comprise a single device, such as a touch screen that allows user inputs, or the user interface may be combination of the touch screen and other input devices mentioned above.

One or more processors 22 may be configured to execute instructions from memory and may perform any methods and/or associated steps indicated by such instructions, such as receiving the acquired signals from the acquisition memory 18 and reconstructing the signal under test from samples generated by the ADCs. In the embodiments disclosed herein, the one or more processors will execute instructions to perform the MLSE process to detect symbols in the waveforms.

While the components of the test and measurement instrument 10 are depicted as being integrated within an oscilloscope 10, it will be appreciated by a person of ordinary skill in the art that any of these components can be external to the oscilloscope 10 and can be coupled to the oscilloscope 10 in any conventional manner (e.g., wired and/or wireless communication media and/or mechanisms). For example, in some examples, display 24 may be remote from oscilloscope 10.

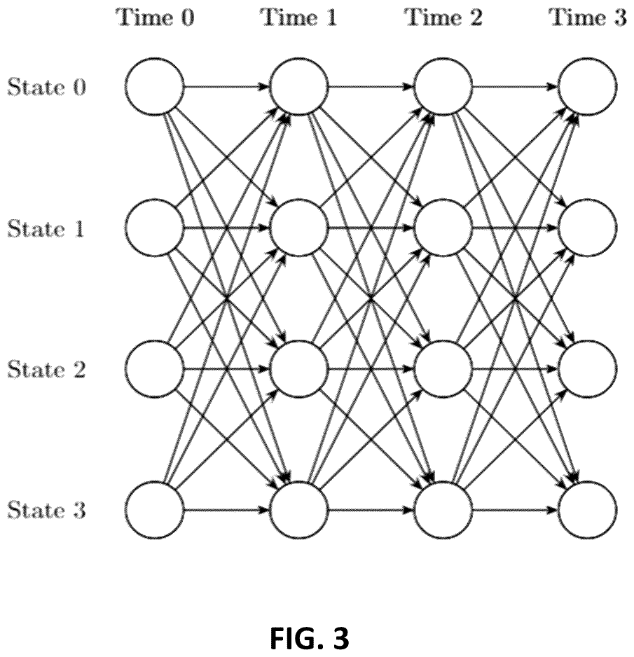

MLSE is more robust to error propagation as MLSE examines all possible paths and selects the optimal one to detect the symbols. One embodiment of MLSE uses a trellis structure such as that shown in FIG. 3 to track all possible paths for symbols. MLSE can achieve the optimal symbol estimation and does not have the symbol error propagation problem. MLSE may be implemented using the Viterbi algorithm. As can be seen in FIG. 3, each state in Times 1 through 3 has paths from each of the other states from the previous time.

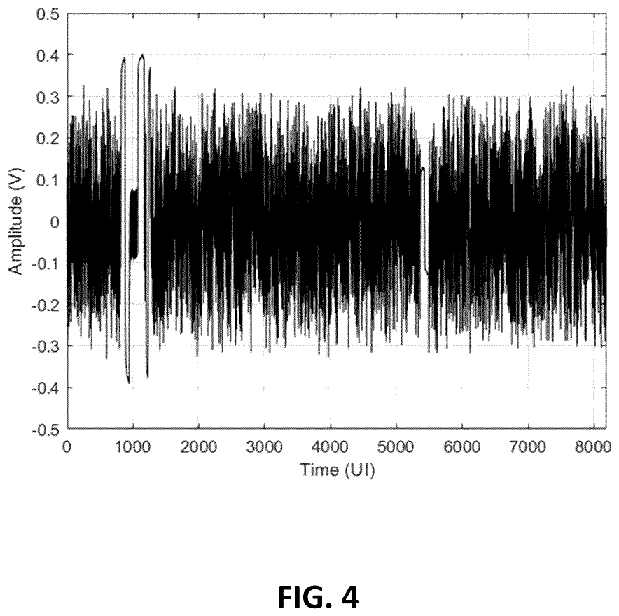

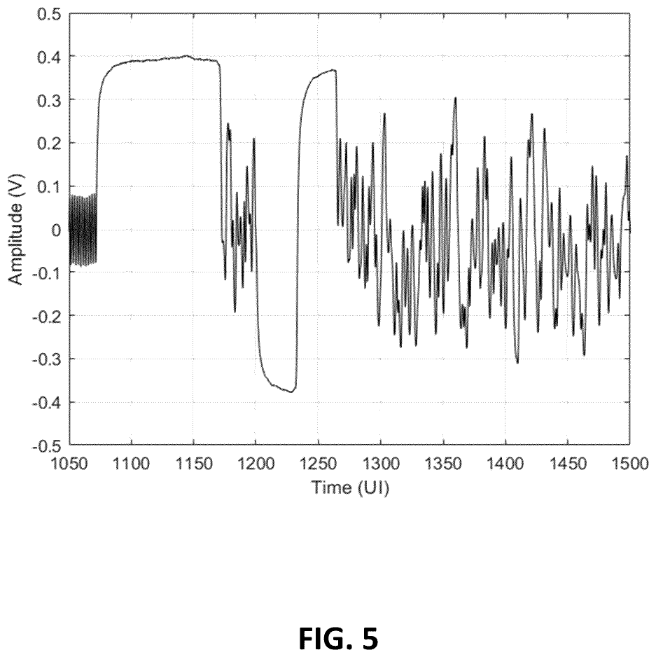

The estimation of the symbols in the waveform acquired by the real-time oscilloscope using the MLSE approach requires channel characterization. Channel characterization can be obtained through various ways, for example, a channel can be characterized with a VNA (vector network analyzer) or a TDR (time-domain reflectometer) instrument. A real-time oscilloscope can also make the channel characterization with a signal with known or detectable pattern. If the pattern is detectable, then it becomes known after the pattern detection. In this document, a PAM4 signal with known pattern is used to describe the process of deriving the impulse response as the estimation of the channel characterization. FIG. 4 shows a PAM4 waveform and FIG. 5 shows a zoomed-in view of the same waveform.

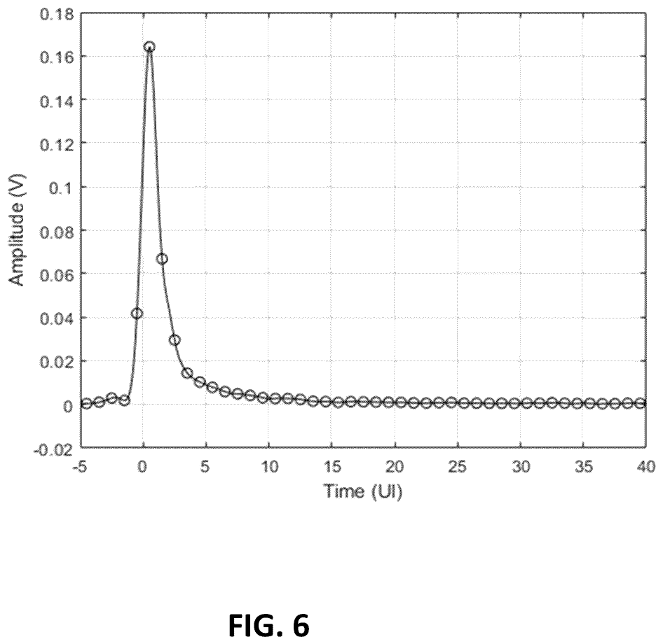

The linear fit pulse response (LFPR) can be extracted from the PAM4 waveform as shown in FIG. 6.

Based on the extracted pulse response, LFPR, the impulse response can be derived from the relationship where the extracted pulse response, hₚᵤₗₛₑ, is the convolution of the ideal pulse and the impulse response. This convolution relationship is represented in the matrix format:

$${Xh}_{impulse} = {h}_{pulse} \qquad ( 1 )$$

Where X is the matrix constructed from the ideal pulse represented by the vector x. For example, x=[0 0 0 0 1 1 1 1 0 0 0 0] for the pulse with 4 samples per (unit interval) UI. The method used to construct matrix X is the same as described in Tan, et al. The method involves flipping and rotating the vector x to create rows for X.

Since there is noise in the extracted pulse response hₚᵤₗₛₑ, to solve the impulse response hᵢₘₚᵤₗₛₑ from Equation (1) with better numerical stability and accuracy, a regularization matrix R=σ·I is introduced, where σ is a small scalar value and I is the identity matrix. The impulse response hᵢₘₚᵤₗₛₑ can be solved from Equation (1) through deconvolution with regularization as:

$${h}_{impulse} = {( {X}^{T} X + R )}^{- 1} {X}^{T} {h}_{pulse} \qquad ( 2 )$$

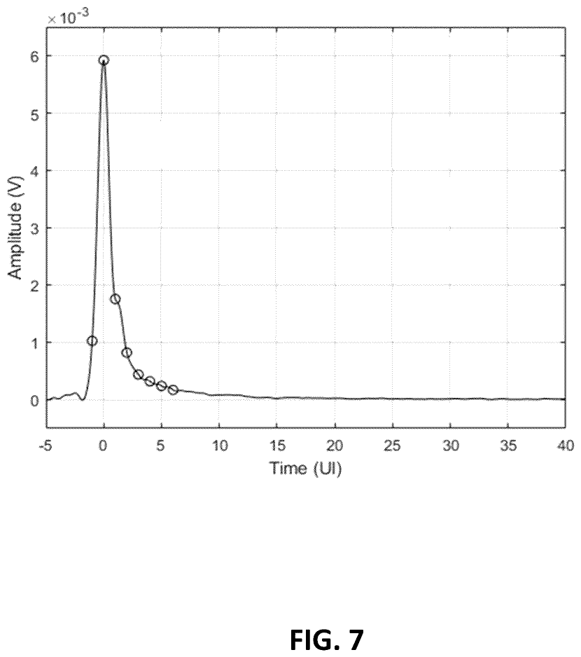

The impulse response calculated from Equation (2) is shown in FIG. 7. The samples at the UI centers around the peak of the impulse shown in FIG. 7 are used as the estimation of the channel characterization for the MLSE routine.

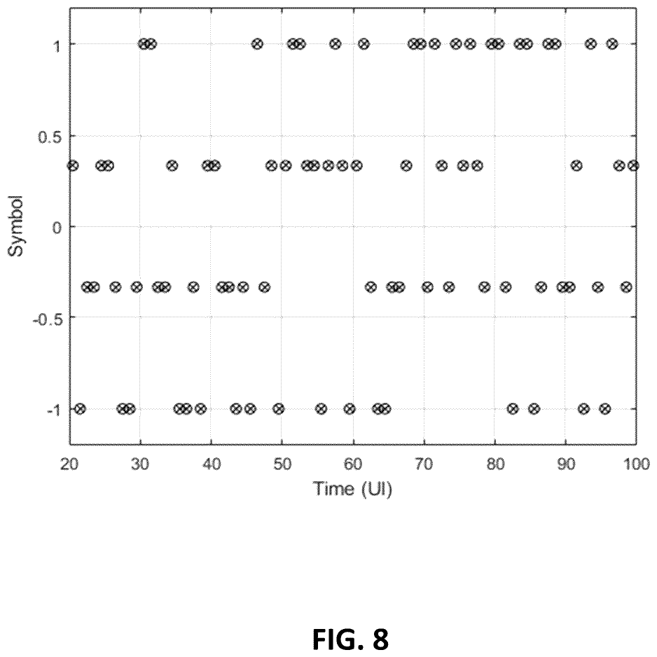

After the channel characterization is obtained from the training waveform with known pattern. The MLSE routine can estimate symbols on any waveforms through that channel and are acquired on the real-time oscilloscopes. For example, the MLSE function in Matlab, takes the inputs of the waveform samples at the UI centers, the channel characterization, the symbol constellation of PAM4, and the configuration of traceback length for the MLSE function, and estimates all the symbols correctly. A portion of the estimated and the actual symbols are shown in FIG. 8.

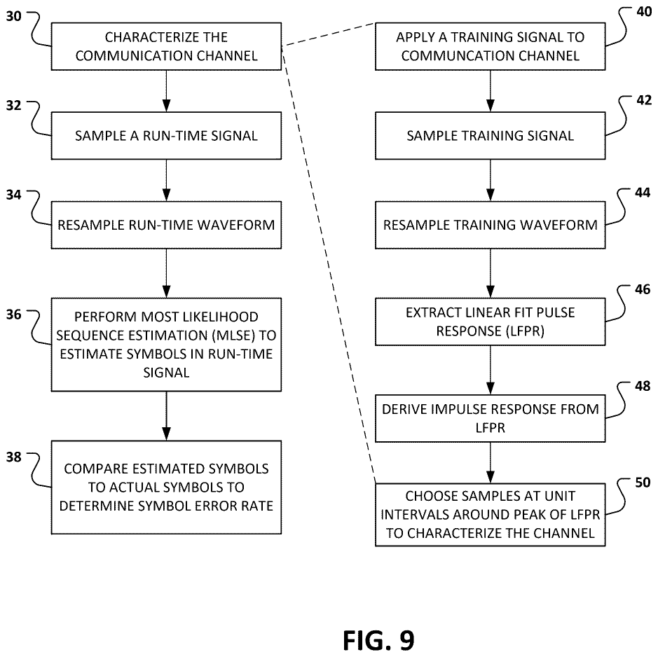

FIG. 9 shows a flowchart of an embodiment of a method of using MLSE to estimate symbols in a waveform. The process begins with characterization of the communication channel at 30. The oscilloscope could obtain the characterization from a vector network analyzer, a TDR instrument, or the oscilloscope can run a training signal, meaning a signal with a known or detectable pattern, such as a PAM4 signal. The channel characterization may only need to occur once for a given channel. The channel characterization would be saved and used again as needed.

Characterizing the channel using the oscilloscope begins with the oscilloscope entering a training mode and then the training signal is sent on the channel at 40. The oscilloscope then samples the training signal at 42, then resamples the signal at 44 to have a predetermined number in each unit interval (UI). In one embodiment, the predetermine number, M, equals 32. The oscilloscope then extracts the linear fit pulse response (LFPR) at 46.

Once the LFPR has been extracted, the oscilloscope determines the impulse response of the channel at 48. In one embodiment, the impulse response is determined through deconvolution with regularization using Equation (2) as discussed above. The samples at the centers of the UIs around the peak of the impulse response that capture most of the energy of the impulse response at 50. These samples are the estimation of the channel characterization. How many samples are captured, as what determines “most” of the energy can be set by the system designer. For example, the designer may define the number of samples to be used, and/or what percentage of the energy level of the peak energy level is considered “most.”

At 50, in the embodiment of channel characterization shown, the number of samples is limited as MLSE has high computational complexity. The computation complexity of MLSE is M^{L} where M is the number of symbols and L is the length of the channel characterization. Because of the exponential function, the L cannot be too large to make the MLSE feasible to implement. For example, Matlab has an upper limit of 2²⁰ on the complexity for MLSE. Since 2²⁰ equals 4¹⁰, it means MLSE function in Matlab cannot completely cover a channel with the impulse response lasts longer than 10 UI for PAM4 signals. This merely provides an example of how the MLSE computational complexity can affect its ability to perform.

Once the channel is characterized at 30, the oscilloscope receives the run-time signal, performs software clock recovery. If the channel characterization is saved, characterizing the channel would involve retrieving the saved channel characterization. The oscilloscope then samples the run-time signal from the DUT at 32 and then resamples to center the samples at the centers of the UIs at 34. The oscilloscope then performs the MLSE process with input of the samples at the UI centers of the waveform, the channel characterization, the symbol constellation, the configuration of the traceback length, to get the symbol estimation as the output. The symbol constellation comprises the amplitude and phase of the symbols in the signal. The traceback length is a configurable parameter that refers to the number of previous symbol estimations the Viterbi algorithm must consider to find the most probable path through the trellis diagram and make a reliable symbol estimation.

The estimated symbols are compared to the actual symbols at 38 to determine a symbol error rate. The symbol error rate determines whether the DUT meets the design specification. If it does not meet the specification, the DUT design needs to be changed.

One should note that the MLSE approach is optimal when the channel characterization is accurate, and the MLSE can fully cover the range of the channel impulse response.

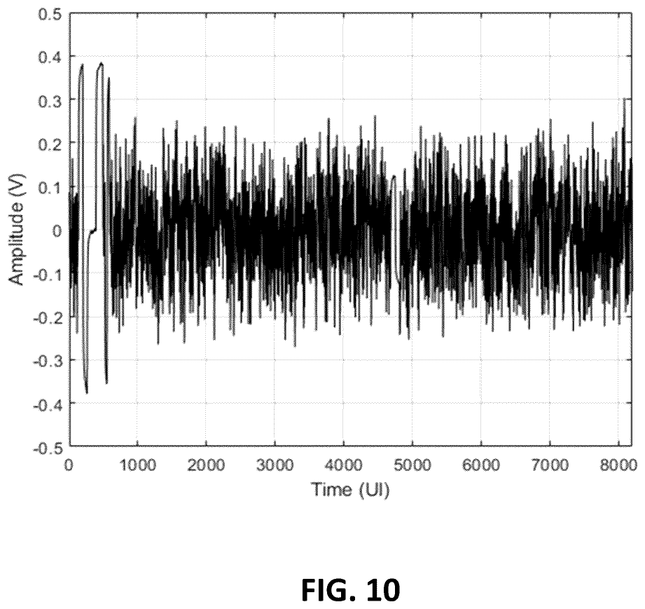

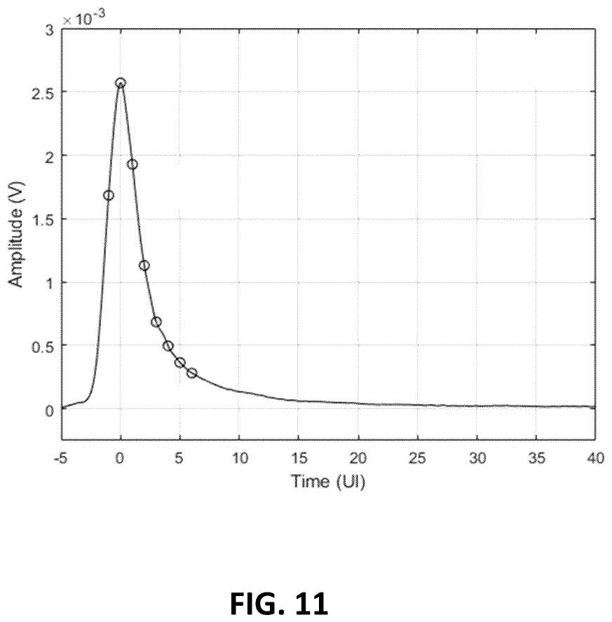

In another numerical example, the pattern waveform after a more lossy channel is shown in FIG. 10. It takes more time for the impulse response of the lossy channel to settle down. The 8 samples picked around the peak of the impulse response could not adequately represent the channel response as shown in FIG. 11.

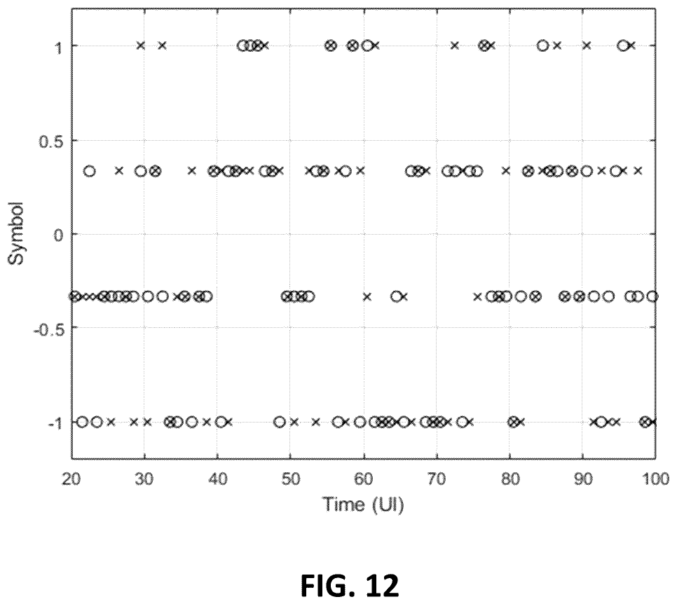

As the channel characterization is not fully and accurately captured by the 8 samples, the MLSE routine generates many symbol estimation errors as shown in FIG. 12. To correct this issue, in some embodiments, the oscilloscope may apply other equalizers such as CTLE and FFE. These can help reduce the duration of the impulse response. Then MLSE can run efficiently with the shortened channel characterization.

The embodiments herein simulate MLSE on the real-time oscilloscopes. Deconvolution with regularization is used to extract the impulse response of the channel to be used as the channel characterization for MLSE. The numerical examples demonstrate that MLSE produces accurate symbol estimation when the channel characterization is accurate with limited length.

Aspects of the disclosure may operate on a particularly created hardware, on firmware, digital signal processors, or on a specially programmed general purpose computer including a processor operating according to programmed instructions. The terms controller or processor as used herein are intended to include microprocessors, microcomputers, Application Specific Integrated Circuits (ASICs), and dedicated hardware controllers. One or more aspects of the disclosure may be embodied in computer-usable data and computer-executable instructions, such as in one or more program modules, executed by one or more computers (including monitoring modules), or other devices. Generally, program modules include routines, programs, objects, components, data structures, etc. that perform particular tasks or implement particular abstract data types when executed by a processor in a computer or other device. The computer executable instructions may be stored on a non-transitory computer readable medium such as a hard disk, optical disk, removable storage media, solid state memory, Random Access Memory (RAM), etc. As will be appreciated by one of skill in the art, the functionality of the program modules may be combined or distributed as desired in various aspects. In addition, the functionality may be embodied in whole or in part in firmware or hardware equivalents such as integrated circuits, FPGA, and the like. Particular data structures may be used to more effectively implement one or more aspects of the disclosure, and such data structures are contemplated within the scope of computer executable instructions and computer-usable data described herein.

The disclosed aspects may be implemented, in some cases, in hardware, firmware, software, or any combination thereof. The disclosed aspects may also be implemented as instructions carried by or stored on one or more or non-transitory computer-readable media, which may be read and executed by one or more processors. Such instructions may be referred to as a computer program product. Computer-readable media, as discussed herein, means any media that can be accessed by a computing device. By way of example, and not limitation, computer-readable media may comprise computer storage media and communication media.

Computer storage media means any medium that can be used to store computer-readable information. By way of example, and not limitation, computer storage media may include RAM, ROM, Electrica, Erasable Programmable Read-Only Memory (EEPRO, flash memory or other memory technology, Compact Disc Read Only Memory (CD-ROM), Digital Video Disc (DVD), or other optical disk storage, magnetic cassettes, magnetic tape, magnetic disk storage or other magnetic storage devices, and any other volatile or nonvolatile, removable or non-removable media implemented in any technology. Computer storage media excludes signals per se and transitory forms of signal transmission.

Communication media means any media that can be used for the communication of computer-readable information. By way of example, and not limitation, communication media may include coaxial cables, fiber-optic cables, air, or any other media suitable for the communication of electrical, optical, Radio Frequency (RF), infrared, acoustic or other types of signals.

### EXAMPLES

Illustrative examples of the disclosed technologies are provided below. An embodiment of the technologies may include one or more, and any combination of, the examples described below.

Example 1 is a real-time oscilloscope, comprising: one or more ports to connect to a device under test (DUT) and to establish a communication channel between the oscilloscope and the DUT; one or more analog-to-digital converters (ADCs) to sample a signal received from the DUT to convert the signal to a waveform; one or more processors configured to execute code to cause the one or more processors to: receive and sample a run-time signal including actual symbols from the DUT to create a run-time waveform; resample the run-time waveform to locate samples at a center of each unit interval; use a channel characterization, the samples at the center of each unit interval, a symbol constellation for the run-time waveform, and a configuration of a traceback length as inputs to a Most Likely Sequence Estimation (MLSE) process to estimate symbols in the run-time waveform; and compare the estimated symbols to the actual symbols to obtain a symbol error ratio.

Example 2 is the real-time oscilloscope of Example 1, wherein the one or more processors are further configured to execute code to cause the one or more processors to characterize the communication channel.

Example 3 is the real-time oscilloscope of Example 2, wherein the code that causes the one or more processors to characterize the communication channel comprises code that causes the one or more processors to receive channel characterization from a vector network analyzer (VNA) or from a time-domain reflectometer (TDR) instrument.

Example 4 is the real-time oscilloscope of Example 2, wherein the code that causes the one or more processors to characterize the communication channel comprises code that causes the one or more processors to: put the oscilloscope into a training mode; apply a training signal having a known pattern to the communication channel; receive and sample the training signal to create a training waveform; resample the training waveform to have a predetermined number of samples per unit interval; extract a linear fit pulse response (LFPR) from the resampled training waveform; derive an impulse response from the LFPR; and choose samples at unit interval centers around a peak of the impulse response to estimate the communication channel characterization.

Example 5 is the real-time oscilloscope of Example 4, wherein the code that causes the one or more processors to derive the impulse response comprises code that causes the one or more processors to: construct a matrix X from a vector of an ideal pulse response; and deconvolve the matrix X from the LFPR.

Example 6 is the real-time oscilloscope of Example 5, wherein the code that causes the one or more processors to deconvolve the matrix X from the LFPR comprises code that causes the one or more processors to deconvolve the matrix X with regularization.

Example 7 is the real-time oscilloscope of Example 4, wherein the code that causes the one or more processors to characterize the communication channel comprises code that causes the one or more processors to: determine that the communication channel has a longer impulse response duration; and apply an equalizer to the samples that shortens the impulse response duration before deriving the impulse response.

Example 8 is the real-time oscilloscope of Example 7, wherein the code that causes the one or more processors to determine the channel has a long impulse response duration comprises code that determines that an amount of time for the impulse response to settle comprises a time that exceeds a predetermined number of unit intervals.

Example 9 is the real-time oscilloscope of Example 7, wherein the code that causes the one or more processors to apply an equalizer to the samples, comprises code that causes the one or more processors to apply one of feedforward equalizer (FFE) or a continuous-time linear equalizer (CTLE).

Example 10 is a method, comprising: sampling a run-time signal received from a device under test (DUT) on a communication channel as a run-time waveform; resampling the run-time signal to locate samples at the center of each unit interval; using a channel characterization, the samples at the center of each unit interval, a symbol constellation for the waveform, and a configuration of a traceback length as inputs to a Most Likely Sequence Estimation (MLSE) process to produce estimated symbols in the run-time signal; and comparing the estimated symbols to actual symbols to determine a symbol error rate.

Example 11 is the method of Example 10, further comprising characterizing the communication channel on a real-time oscilloscope using a training signal having a known or detected pattern to produce a communication channel characterization.

Example 12 is the method of Example 11, wherein characterizing the communication channel comprises receiving channel characterization from a vector network analyzer (VNA) or from a time-domain reflectometer (TDR) instrument.

Example 13 is the method of Example 11, wherein characterizing the communication channel comprises: putting the oscilloscope into a training mode; applying the training signal to the communication channel; receiving and sampling the training signal to create a training waveform; resampling the training waveform to have a predetermined number of samples per unit interval; extracting a linear fit pulse response (LFPR) from the resampled training waveform; deriving an impulse response from the LFPR; and choosing samples at unit interval centers around a peak of the impulse response to estimate the communication channel characterization.

Example 14 is the method of Example 13, wherein deriving the impulse response comprises: constructing a matrix, X, from a vector of an ideal pulse response; and deconvolving the matrix X from the LFPR.

Example 15 is the method of Example 14, wherein deconvolving the matrix X from LFPR comprises deconvolving the matrix X with regularization.

Example 16 is the method of Example 13, wherein characterizing the communication channel comprises: determining that the communication channel has a long impulse response duration; and applying an equalizer to the samples to shorten the impulse response duration before deriving the impulse response.

Example 17 is the method of Example 16, wherein determining the communication channel has a long impulse response duration comprises determining that an amount of time for the impulse response to settle comprises a time that exceeds a predetermined number of unit intervals.

Example 18 is the method of Example 16, wherein applying an equalizer to the samples, comprises applying one of feedforward equalizer (FFE) or a continuous-time linear equalizer (CTLE).

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Additionally, this written description makes reference to particular features. It is to be understood that the disclosure in this specification includes all possible combinations of those particular features. Where a particular feature is disclosed in the context of a particular aspect or example, that feature can also be used, to the extent possible, in the context of other aspects and examples.

Also, when reference is made in this application to a method having two or more defined steps or operations, the defined steps or operations can be carried out in any order or simultaneously, unless the context excludes those possibilities.

Although specific examples of the invention have been illustrated and described for purposes of illustration, it will be understood that various modifications may be made without departing from the spirit and scope of the invention. Accordingly, the invention should not be limited except as by the appended claims.

1. A real-time oscilloscope, comprising:
one or more ports to connect to a device under test (DUT) and to establish a communication channel between the oscilloscope and the DUT;
one or more analog-to-digital converters (ADCs) to sample a signal received from the DUT to convert the signal to a waveform;
one or more processors configured to execute code to cause the one or more processors to:
receive and sample a run-time signal including actual symbols from the DUT to create a run-time waveform;
resample the run-time waveform to locate samples at a center of each unit interval;
use a communication channel characterization, the samples at the center of each unit interval, a symbol constellation for the run-time waveform, and a configuration of a traceback length as inputs to a Most Likely Sequence Estimation (MLSE) process to estimate symbols in the run-time waveform; and
compare the estimated symbols to the actual symbols to obtain a symbol error ratio.

2. The real-time oscilloscope as claimed in claim 1, wherein the one or more processors are further configured to execute code to cause the one or more processors to characterize the communication channel.

3. The real-time oscilloscope as claimed in claim 2, wherein the code that causes the one or more processors to characterize the communication channel comprises code that causes the one or more processors to receive the communication channel characterization from a vector network analyzer (VNA) or from a time-domain reflectometer (TDR) instrument.

4. The real-time oscilloscope as claimed in claim 2, wherein the code that causes the one or more processors to characterize the communication channel comprises code that causes the one or more processors to:
put the oscilloscope into a training mode;
apply a training signal having a known pattern to the communication channel;
receive and sample the training signal to create a training waveform;
resample the training waveform to produce a resampled training waveform having a predetermined number of samples per unit interval;
extract a linear fit pulse response (LFPR) from the resampled training waveform;
derive an impulse response from the LFPR; and
choose samples at unit interval centers around a peak of the impulse response to estimate the communication channel characterization.

5. The real-time oscilloscope as claimed in claim 4, wherein the code that causes the one or more processors to derive the impulse response comprises code that causes the one or more processors to:
construct a matrix X from a vector of an ideal pulse response; and
deconvolve the matrix X from the LFPR.

6. The real-time oscilloscope as claimed in claim 5, wherein the code that causes the one or more processors to deconvolve the matrix X from the LFPR comprises code that causes the one or more processors to deconvolve the matrix X with regularization.

7. The real-time oscilloscope as claimed in claim 4, wherein the code that causes the one or more processors to characterize the communication channel comprises code that causes the one or more processors to:
determine that the communication channel has a longer impulse response duration; and
apply an equalizer to the samples that shortens the impulse response duration before deriving the impulse response.

8. The real-time oscilloscope as claimed in claim 7, wherein the code that causes the one or more processors to determine the channel has a long impulse response duration comprises code that determines that an amount of time for the impulse response to settle comprises a time that exceeds a predetermined number of unit intervals.

9. The real-time oscilloscope as claimed in claim 7, wherein the code that causes the one or more processors to apply an equalizer to the samples, comprises code that causes the one or more processors to apply one of feedforward equalizer (FFE) or a continuous-time linear equalizer (CTLE).

10. A method, comprising:
sampling a run-time signal received from a device under test (DUT) on a communication channel as a run-time waveform;
resampling the run-time signal to locate samples at the center of each unit interval;
using a communication channel characterization, the samples at the center of each unit interval, a symbol constellation for the waveform, and a configuration of a traceback length as inputs to a Most Likely Sequence Estimation (MLSE) process to produce estimated symbols in the run-time signal; and
comparing the estimated symbols to actual symbols to determine a symbol error rate.

11. The method as claimed in claim 10, further comprising characterizing the communication channel on a real-time oscilloscope using a training signal having a known or detected pattern to produce the communication channel characterization.

12. The method as claimed in claim 11, wherein characterizing the communication channel comprises receiving channel characterization from a vector network analyzer (VNA) or from a time-domain reflectometer (TDR) instrument.

13. The method as claimed in claim 11, wherein characterizing the communication channel comprises:
putting the oscilloscope into a training mode;
applying the training signal to the communication channel;
receiving and sampling the training signal to create a training waveform;
resampling the training waveform to have a predetermined number of samples per unit interval;
extracting a linear fit pulse response (LFPR) from the resampled training waveform;
deriving an impulse response from the LFPR; and
choosing samples at unit interval centers around a peak of the impulse response to estimate the communication channel characterization.

14. The method as claimed in claim 13, wherein deriving the impulse response comprises:
constructing a matrix, X, from a vector of an ideal pulse response; and
deconvolving the matrix X from the LFPR.

15. The method as claimed in claim 14, wherein deconvolving the matrix X from LFPR comprises deconvolving the matrix X with regularization.

16. The method as claimed in claim 13, wherein characterizing the communication channel comprises:
determining that the communication channel has a long impulse response duration; and
applying an equalizer to the samples to shorten the impulse response duration before deriving the impulse response.

17. The method as claimed in claim 16, wherein determining the communication channel has a long impulse response duration comprises determining that an amount of time for the impulse response to settle comprises a time that exceeds a predetermined number of unit intervals.

18. The method as claimed in claim 16, wherein applying an equalizer to the samples, comprises applying one of feedforward equalizer (FFE) or a continuous-time linear equalizer (CTLE).
